(19) United States
(12) Patent Application Publication
(10) Pub. No.: US 2025/0269744 A1
(43) Pub. Date: Aug. 28, 2025

(54) MODULAR CHARGING SYSTEM

(71) Applicant: Toyota Motor Engineering & Manufacturing North America, Inc., Plano, TX (US)

(72) Inventors: Norman N. Lu, Ann Arbor, MI (US); Geoffrey D. Gaither, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/678,393

(22) Filed: May 30, 2024

Related U.S. Application Data
(60) Provisional application No. 63/558,815, filed on Feb. 28, 2024.

(51) Int. Cl. B60L 53/14; H02J 3/32; H02J 7/34; H02J 7/35

(52) U.S. Cl. CPC B60L 53/14; H02J 3/322; H02J 7/342; H02J 7/35; H02J 2207/20

(57) ABSTRACT

Described are examples of a modular charging system. In one example, a modular charging system includes a base charging module configured to provide alternating current (“AC”) charging capabilities to charge a battery via a charging port. The base charging system is configured to be selectively connected to an AC backup module that additionally enables AC discharging capabilities to send electricity from the battery to a residential electrical system and/or a direct-current (“DC”) grid integration module that additionally enables DC discharging capabilities to send electricity from the battery to a utility grid and DC charging capabilities to charge the battery.

### CROSS-REFERENCE TO RELATED APPLICATION

This application claims priority to U.S. Provisional Patent Application No. 63/558,815, filed on Feb. 28, 2024, the contents of which are hereby incorporated by reference in its entirety.

### TECHNICAL FIELD

The subject matter described herein relates, in general, to a modular charging system for charging devices having batteries, such as battery electric vehicles (“BEVs”) and plug-in hybrid electric vehicles (“PHEVs”).

### BACKGROUND

The background description provided is to present the context of the disclosure generally. Work of the inventors, to the extent it may be described in this background section, and aspects of the description that may not otherwise qualify as prior art at the time of filing, are neither expressly nor impliedly admitted as prior art against the present technology.

Some vehicles, such as BEVs and PHEVs, utilize electricity for propulsion. Moreover, BEVs generally rely on one or more electric motors for propulsion. In comparison, PHEVs combine one or more electric motors with a gasoline engine. As such, these types of vehicles also include batteries that are used to store electricity to drive the one or more electric motors of these vehicles. Charging of these batteries can be performed in a number of different locations.

Home-based charging, where the charger is located at a residence, has been found to be fairly convenient to operators of these types of vehicles as it allows the batteries of these vehicles to be charged when the operator is home. For example, while the operator is sleeping or otherwise located at their residence, the battery can be charged, reducing the need for the operator to make a special trip to a charging station. Furthermore, the charging of these batteries is fairly slow compared to conventional gasoline refueling, and the ability to charge the vehicle at the operator's residence minimizes the inconvenience of lengthy charge times.

Home-based chargers are usually Level 1 or Level 2 type systems. Level 1 charging may use a standard 120-volt alternating current (“AC”) outlet, similar to what one would use for household appliances. It delivers a lower amount of power, typically around 1.3-2.0 kilowatts (kW). Level 2 charging may use a 240-volt AC outlet, similar to what one would use for a clothes dryer or oven. It delivers a significantly higher power output, typically ranging from 6.2 kW to 19.2 kW. Generally, Level 1 chargers are slow at charging batteries, and as such, Level 2 chargers are generally preferred. More recently, Level 3 chargers, also known as direct-current (“DC”) chargers, have become more popular. Level 3 chargers deliver DC power at a much higher voltage than Level 1 or Level 2 chargers, reducing charging time further.

Further still, some technologies allow the battery of the vehicle to provide power to the home (“V2H”) and/or grid (“V2G”). As such, V2H essentially allows the battery of the vehicle to provide power to a residence when needed, for example, during a blackout or power interruption. V2G allows the battery of the vehicle to provide power to the grid, essentially turning the battery of the vehicle into a mobile energy storage unit, contributing to the overall grid stability and potentially offering benefits to both individuals and utilities.

### SUMMARY

This section generally summarizes the disclosure and is not a comprehensive explanation of its full scope or all its features.

In one embodiment, a modular charging system includes a base charging module configured to provide AC charging capabilities to charge a battery via a charging port. The base charging system is configured to be selectively connected to an AC backup module that additionally enables AC discharging capabilities to send electricity from the battery to a residential electrical system and/or a DC grid integration module that additionally enables DC discharging capabilities to send electricity from the battery to a utility grid and DC charging capabilities to charge the battery.

In another embodiment, an AC backup module is configured to be selectively connected to a base charging module. The AC backup module enables AC discharging capabilities to the base charging module to send electricity from a battery connected to the base charging module via a charging port to a residential electrical system.

In yet another embodiment, a DC grid integration module is configured to be selectively connected to a base charging module. The DC grid integration module enables DC discharging capabilities to send electricity from a battery connected to the base charging module via a charging port to a utility grid and DC charging capabilities to charge the battery.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates a modular charging system charging the battery of the vehicle.

FIG. 2 illustrates a block diagram of a modular charging system that can connect to various components, such as the battery of a vehicle, utility grid, a solar array, and/or a stationary battery.

FIGS. 3A-3C illustrate functional block diagrams of a modular charging system at different stages of upgradability.

FIGS. 4A-4C illustrate different examples of a modular charging system.

### DETAILED DESCRIPTION

As mentioned in the background section, there is demand for home chargers for charging batteries of BEVs and/or PHEVs. Additionally, there have been several advancements in charging technologies, including Level 3 charging, V2H, and V2G capabilities. In particular, prior art solutions require that when one wishes to upgrade their home charger to take advantage of newer technologies, the prior charger must be removed, and a new charger with the additional capabilities must be installed. This is a waste of both hardware and installation costs.

Disclosed herein are different examples of a modular charging system that allows one to add additional capabilities by adding appropriate modules. In one example, a base charging module can provide charging capabilities to charge a battery via a charging port, such as the battery of the vehicle. The base charging system can be upgraded to include additional capabilities by adding an AC backup module that enables AC discharging capabilities and/or a DC grid integration module that enables DC charging/discharging capabilities.

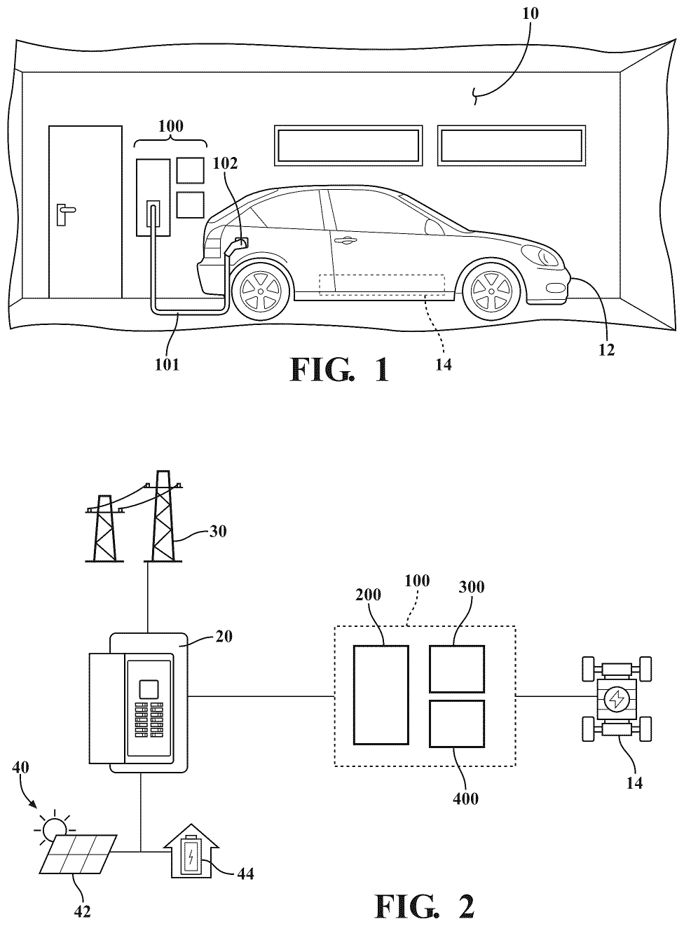

FIG. 1 illustrates a residential garage 10 having a vehicle 12 parked within. The vehicle 12 can be any form of powered transport. In one or more implementations, the vehicle 12 is an automobile. While arrangements will be described herein with respect to automobiles, it will be understood that embodiments are not limited to automobiles. In some implementations, the vehicle 12 may be any robotic device or form of powered transport. In this example, the vehicle 12 may be a BEV and/or a PHEV and therefore includes a battery 14 that may be charged. Here, illustrated, is one example of a modular charging system 100 that can charge the battery 14 of the vehicle 12 when a charging port 102 of a charging cable 101 is connected to the vehicle 12.

Referring to FIG. 2, as will be explained in greater detail later, the modular charging system 100 can include various modules that can upgrade the capabilities of the modular charging system 100. For example, depending on what modules form the modular charging system 100, the modular charging system 100 may able to charge the battery 14, allow the battery 14 to act as a backup energy supply to a residential electrical system 20, supply electricity from the battery 14 to a utility grid 30 and/or receive and/or send electricity from external power sources 40, such as a solar array 42 and/or a stationary battery 44, among other things.

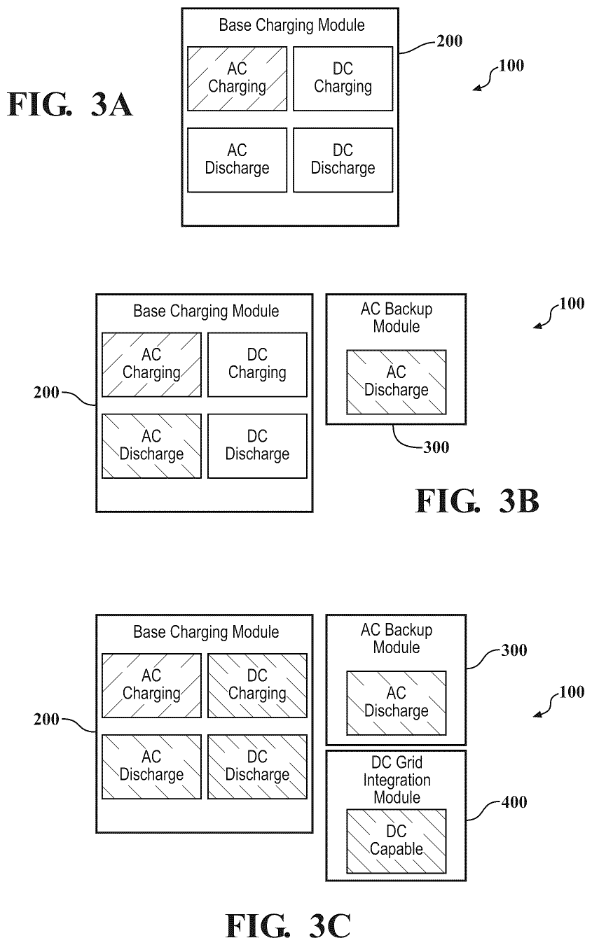

To better understand which capabilities are enabled when adding appropriate modules, reference is made to FIGS. 3A-3C, which illustrates functional block diagrams of a modular charging system 100 at different stages of upgradability. Moreover, FIG. 3A illustrates the modular charging system 100, including a base charging module 200 that has the capability of providing AC charging to a battery, such as a battery of a BEV or a PHEV. As best shown in FIG. 3B, when it becomes desirable, an AC backup module 300 can be connected to the base charging module 200 to provide additional capabilities, such as AC discharge capabilities, which allow a battery 14 of a vehicle 12 connected to the base charging module 200 to provide backup capabilities to a residential electrical system 20. For example, if there is a power outage or other power interruption, the battery 14 of the vehicle 12 utilizing the base charging module 200 and the AC backup module 300 can essentially act as an emergency power supply for the home, similar to a home generator.

When additional capabilities are desired, the modular charging system 100 can be upgraded further, for example, with the addition of the DC grid integration module 400 to the modular charging system 100, as shown in FIG. 3C. The DC grid integration module 400 provides DC capabilities that allow for DC charging (i.e., Level 3 charging) and/or DC discharging of the battery 14 of a vehicle 12 connected to the base charging module 200. In this example, the DC grid integration module 400 provides DC discharging capabilities to send electricity from the battery 14 via the base charging module 200 to a utility grid 30 and/or provides DC charging capabilities to charge the battery 14 via the base charging module 200.

As such, the modular charging system 100 can be upgraded when additional capabilities are desired. Instead of having to completely remove obsolete components and install newer components, the modular charging system 100 allows a convenient and cost-effective path for upgrading a home charging system when additional capabilities and technologies are developed. In some cases, the base charging module 200, the AC backup module 300, and/or the DC grid integration module 400 may each be located in separate housings that can be connected to each other using appropriate wiring and/or connectors.

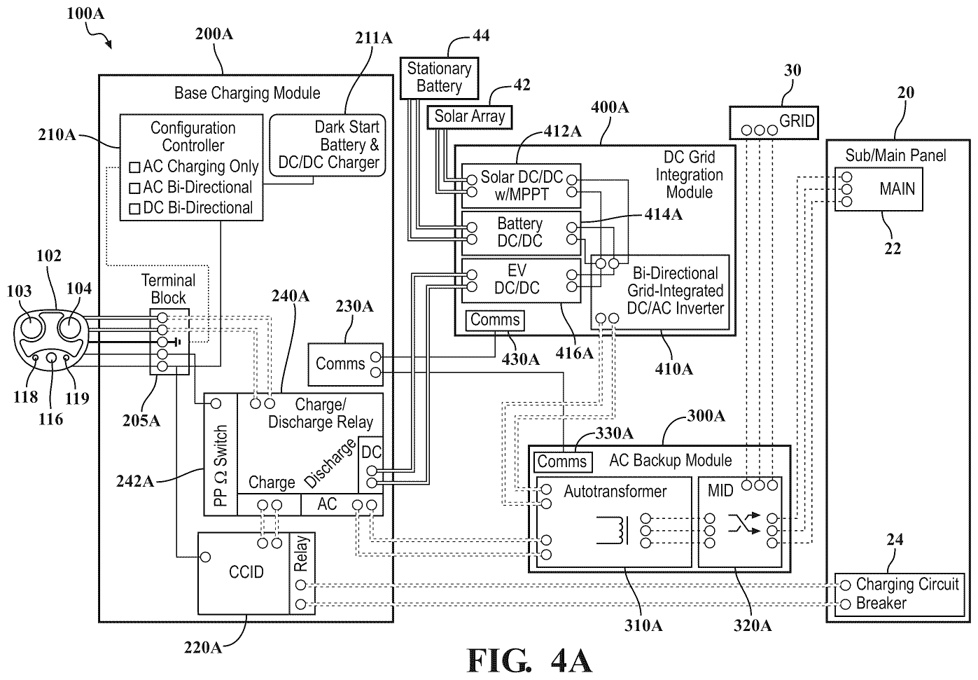

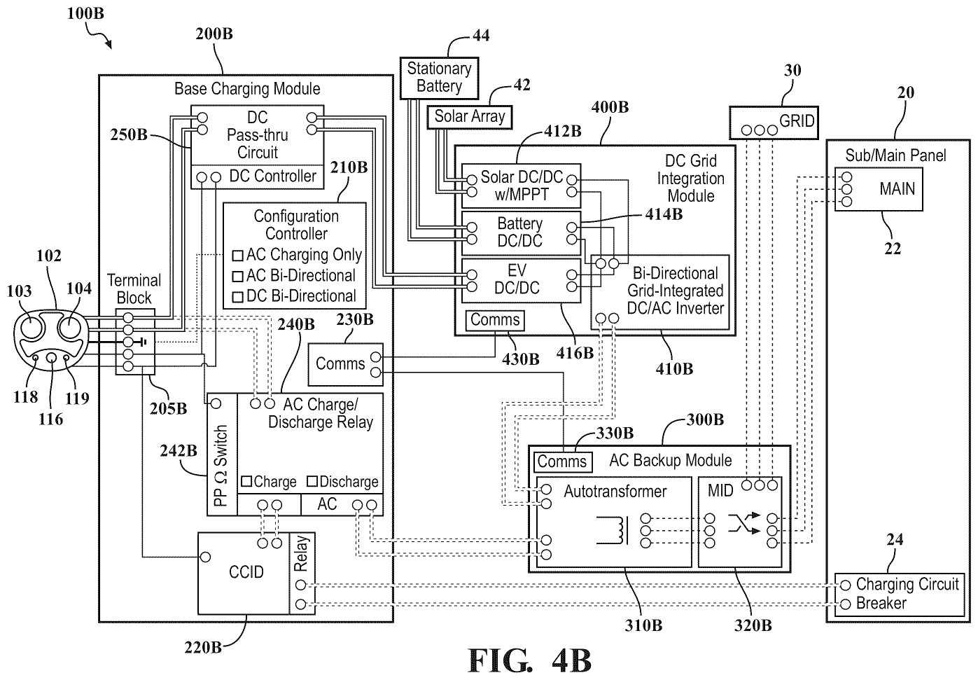

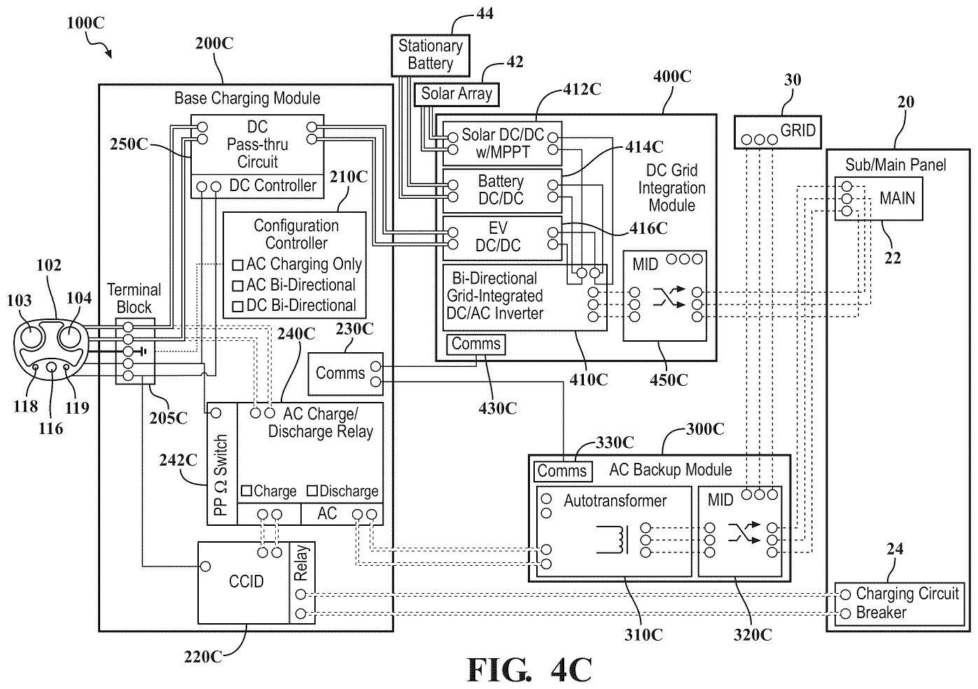

The modular charging system 100 and the various modules, including the base charging module 200, the AC backup module 300, in the DC grid integration module 400 can take various forms and may utilize various components. Examples of these components are shown and described in FIGS. 4A-4C. However, it should be understood that the examples of these components in FIGS. 4A-4C are merely examples. As such, the examples of these components may include more, fewer, or different types of components depending on the needs of any one particular application.

Referring to FIG. 4A, illustrated is one example of a modular charging system 100A. Here, the modular charging system 100A includes a base charging module 200A. The base charging module 200A can be selectively connected to an AC backup module 300A and/or a DC grid integration module 400A when additional capabilities are desired. Along with these modules, also illustrated is the utility grid 30, a main panel 22 for a residential electrical system 20, and a charging port 102 that can connect to a vehicle to charge the battery of the vehicle, such as the vehicle 12 and the battery 14 of FIG. 1.

The charging port 102 may be located at the end of the cable, such as the cable 101 of FIG. 1, which extends from the base charging module 200A and can be selectively connected to another port located on the vehicle 12. The charging port 102 can take any one of a number of different forms and may follow a number of different standards. In this example, the charging port 102 is shown to be a North American Charging Standard (“NACS”) type port. However, it should be understood that the charging port 102 can follow any one of a number of different standards.

Here, the charging port 102 utilizes five different pins, including a DC+/L1 pin 104 that provides either the positive side of the DC voltage link or, when using AC, provides either Line 1 in a split-phase connection or the sole Line in a single-phase connection, a DC−/L2 pin 103 that provides both the negative side of the DC voltage link or when using AC it can serve as either Line 2 in a split-phase connection or the neutral in a single-phase connection, a ground pin 116 that provides a connection between the earth and the vehicle chassis, a control pilot pin 119 used as a digital communication path between the modular charging system 100A and a vehicle, and a proximity pilot pin 118 that carries a low-voltage signal and is used to determine the status of the vehicle connector. The charging port 102, in this example, is connected to base charging module 200A via a terminal block 205A.

The base charging module 200A may also include a configuration controller 210A that allows the operator to choose the mode that they want the modular charging system 100A to operate in. In some cases, the mode may be dependent on the type of modules that form the modular charging system 100A. For example, if the modular charging system 100A only includes the base charging module 200A, the configuration controller 210A may only be able to operate in an AC charging mode. However, if the modular charging system 100A also includes the AC backup module 300A and/or the DC grid integration module 400A, the configuration controller 210A may also allow AC bidirectional charging/discharging and/or DC bidirectional charging/discharging, respectively. The configuration controller 210A may be connected to a dark start battery 211A and/or a DC/DC charger for providing power to the configuration controller 210A. The configuration controller 210A may be connected to a communication system 230A that allows the configuration controller 210A to communicate with a communication system 330A of the AC backup module 300A and/or a communication system 430A of the DC grid integration module 400A. This essentially allows the configuration controller 210A to control the various components of the AC backup module 300A and/or the DC grid integration module.

The base charging module 200A may also include a charge/discharge relay 240A and/or a charge circuit interrupting device 220A. Moreover, the charge/discharge relay 240A is connected to pins 103 and 104 of the charging port 102 and is controlled by the control pilot pin 119. Moreover, depending on the signal sent on the control pilot pin 119 to a pilot pin switch 242A, the charge/discharge relay 240A may allow for the charging/discharging (either AC or DC) of a battery of a vehicle connected to the charging port 102. The charge circuit interrupting device 220A acts as a safety device that allows for the charging of the battery of a vehicle when connected to the charging port 102. Moreover, if the proximity pilot pin 118 indicates that the charging port 102 is not connected to a chargeable device, such as a vehicle, the charge circuit interrupting device 220A prevents electricity from being provided to the pins 103 and 104 of the charging port 102. The charge circuit interrupting device 220A may be connected to a circuit breaker 24 of a main panel 22 of a residential electrical system 20 that distributes electricity from the residential unit.

In situations where the modular charging system 100 only includes the base charging module 200A, the charge circuit interrupting device 220A receives electricity from the main panel 22 via a 240V AC connection. This electricity is routed to the charging port 102 via the charge circuit interrupting device 220A and the charge/discharge relay 240A. As such, in this configuration, the modular charging system 100A acts as a Level 2 charger.

However, as explained before, the modular charging system 100A can be upgraded to include AC discharging capabilities by connecting the AC backup module 300A to the base charging module 200A. A specialized or standard connector may be used to provide a connection between the AC backup module 300A and the base charging module 200A. In one example, the AC backup module 300A includes a neutral-forming transformer 310A that may be connected to the charge/discharge relay 240A. The neutral-forming transformer 310A is, in one example, an electrical transformer with only one winding. In the neutral-forming transformer 310A, segments of the same winding serve as both the primary and secondary winding sides of the transformer. Unlike a conventional transformer, which has separate primary and secondary windings, the neutral-forming transformer 310A lacks electrical isolation between these circuits. The neutral-forming transformer 310A is particularly advantageous in this application as it is compact, cost-effective, offers a higher volt-ampere rating, exhibits lower losses, has lower leakage resistance, and has a lower excitation current.

When the configuration controller 210A is set to an AC bidirectional configuration, the neutral-forming transformer 310A can receive electricity from the battery of the vehicle via the charging port 102 from the charge/discharge relay 240A, which then converts the electricity from 240 V AC to 120 V AC. After conversion, the electricity can be provided to the utility grid 30 and/or the main panel 22 via a microgrid interconnection device 320A, which essentially acts as an isolation switch and can change connections between the utility grid 30 and the main panel 22. The microgrid interconnection device 320A can be connected to the residential electrical system 20 and the utility grid 30 via 120 V split phase connections. This essentially allows for bidirectional capabilities wherein electricity stored in the battery of a vehicle that is connected to the charging port 102 can be transmitted to the residential electrical system 20 to allow the battery of the vehicle to act as an emergency power source for the residence.

When further capabilities are desired, the modular charging system 100A can be further upgraded to include the DC grid integration module 400A. The DC grid integration module 400A adds Level 3 charging capabilities but also bidirectional capabilities, allowing the battery 14 of the vehicle 12 to be connected to the utility grid 30. Moreover, the DC grid integration module 400A includes a bidirectional grid-integrated DC/AC inverter 410A that functions to convert DC to AC. The bidirectional grid-integrated DC/AC inverter 410A is connected to a DC/DC converter 416A, which is connected to the charge/discharge relay 240A of the base charging module 200A via a DC electrical connection. This connection between the charge/discharge relay 240A and the DC/DC converter 416A may be accomplished through the use of a standard or specialized connection, allowing the base charging module 200A to be easily connected to the DC grid integration module 400A.

The DC grid integration module 400A can also be connected to other external power sources 40, such as a solar array 42 and/or a stationary battery 44. In this example, the solar array 42 is connected to the bidirectional grid-integrated DC/AC inverter 410A via a DC/DC converter 412A that may include maximum power point tracking (“MPPT”) capabilities. By so doing, the solar array 42 can be used to charge the battery 14 of the vehicle via the charging port 102, but it can also be used to provide electricity to the utility grid 30 via the AC backup module 300A.

Additionally, as mentioned before, the DC grid integration module 400A can be connected to a stationary battery 44. In this example, the stationary battery 44 is connected to the bidirectional grid-integrated DC/AC inverter 410A via a DC/DC converter 414A. As such, the stationary battery can be used to charge the battery 14 of the vehicle via the charging port 102, but can also be used to provide electricity to the utility grid 30 via the AC backup module 300A.

In this example, the bidirectional grid-integrated DC/AC inverter 410A is connected to the AC backup module 300A via a 240 V electrical connection. Similar to what was mentioned before, the connection between the bidirectional grid-integrated DC/AC inverter 410A and the bidirectional grid-integrated DC/AC inverter 410A may be accomplished through a specialized or standard connection to allow for easy connection between the DC grid integration module 400A and the AC backup module 300A.

When connected as shown, the DC grid integration module 400A may receive AC from the AC backup module 300A. This AC can then be converted to DC by the bidirectional grid-integrated DC/AC inverter 410A. After being converted by the bidirectional grid-integrated DC/AC inverter 410A, this DC is provided to the DC/DC converter 416A and then to the charging port 102 via the charge/discharge relay 240A, thus enabling Level 3 charging when the configuration controller 210A is set to DC bidirectional.

In addition to Level 3 charging capabilities, the DC grid integration module 400A also allows for providing electricity from the battery 14 of the vehicle via the charging port 102 to the utility grid 30. This is accomplished by having electricity received from charging port 102 provided to pass through the charge/discharge relay 240A, which is then provided to the bidirectional grid-integrated DC/AC inverter 410A. DC received by the bidirectional grid-integrated DC/AC inverter 410A is converted to AC and provided to the neutral-forming transformer 310A of the AC backup module 300A. From there, the AC is then provided to the microgrid interconnection device 320A, which then can provide this electricity to the utility grid 30.

As such, the modular charging system 100A can be upgraded over time to add capabilities when needed. As stated before, the base charging module 200A can initially provide Level 1 and Level 2 charging capabilities. When adding the AC backup module 300A, the capabilities of the modular charging system 100A are enhanced to include the ability to send electricity to the residential electrical system 20 for a battery connected to the charging port 102, essentially allowing the battery to act as a backup power source. When adding the DC grid integration module 400A, the capabilities of the modular charging system 100A are enhanced to include Level 3 charging and the ability to provide electricity to the utility grid 30.

FIG. 4B illustrates a different example of a modular charging system 100B. Here, like reference numerals have been utilized to refer to like elements, with the exception that these elements are now followed by the letter “C.” For example, any description regarding the base charging module 200A of the modular charging system 100A is equally applicable to the base charging module 200B of the modular charging system 100B. As such, prior descriptions of these elements are equally applicable unless otherwise stated and will not be provided again.

The modular charging system 100B differs from the modular charging system 100A in that it includes a DC pass-through circuit 250B that acts as a conduit for sending and receiving DC from the DC grid integration module 400B. As such, instead of routing DC to the charging port 102 via a charge/discharge relay 240A, this example of the modular charging system 100B now routes DC to the charging port 102 via a DC pass-through circuit 250B. In addition, the base charging module 200B has replaced the charge/discharge relay 240A with an AC charge/discharge relay 240B. Finally, the terminal block 205A of the base charging module 200A has been replaced with an AC/DC switch 205B that can control the flow of either AC or DC. As such, depending on the type of charging or discharging, the AC/DC switch 205B can be set accordingly. For example, for AC charging and discharging, the AC/DC switch 205B may be switched to connect to the AC components of the modular charging system 100B. On the other hand, for DC charging and discharging, the AC/DC switch 205B may be switched to connect to the DC components of the modular charging system 100B.

FIG. 4C illustrates a different example of a modular charging system 100C. Here, like reference numerals have been utilized to refer to like elements, with the exception that these elements are now followed by the letter “C.” As such, prior descriptions of these elements are equally applicable unless otherwise stated and will not be provided again.

One notable aspect of the modular charging system 100C is that this example allows one to add the DC grid integration module 400C to the base charging module 200C without the need for the AC backup module 300C. Moreover, as will be described later, the DC grid integration module 400C can be directly connected to the utility grid 30 and/or the residential electrical system 20 without needing the AC backup module 300C. As such, this allows one to upgrade the modular charging system 100C from AC charging capabilities directly to DC charging/discharging capabilities. This is different from the modular charging systems 100A and 100B, which first require adding the AC backup modules 300A and 300B before adding the DC grid integration modules 400A and 400B, respectively.

As such, in this example, the modular charging system 100C differs from that of the modular charging system 100B in that the AC backup module 300C is not connected to the DC grid integration module 400C. Moreover, the DC grid integration module 400C includes a microgrid interconnection device 450C, which allows the DC grid integration module 400C to be directly connected to the residential electrical system 20 and/or the utility grid 30. Additionally, in some cases, the bidirectional grid-integrated DC/AC inverter 410C may convert the DC received from the DC pass-through circuit 250C to 120 V AC, which is then provided to the microgrid interconnection device 450C and then to the utility grid 30 and/or the residential electrical system 20.

The modular charging systems 100A, 100B, and 100C allow one to add additional capabilities without completely replacing an already installed charger. Moreover, the modular charging systems 100A, 100B, and 100C allow a path of upgradability from a basic Level 2 AC charging system to a more advanced AC charging/discharging system and/or DC charging/discharging system. These capabilities allow the modular charging systems 100A, 100B, and 100C to add additional features, such as V2H and V2G capabilities.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations.

The following includes definitions of selected terms employed herein. The definitions include various examples and/or forms of components that fall within the scope of a term and that may be used for various implementations. The examples are not intended to be limiting. Both singular and plural forms of terms may be within the definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

What is claimed is:

1. A system comprising:
a base charging module configured to provide alternating current (“AC”) charging capabilities to charge a battery via a charging port, the base charging system configured to be selectively connected to at least one of:
an AC backup module that additionally enables AC discharging capabilities to send electricity from the battery to a residential electrical system; and
a direct-current (“DC”) grid integration module that additionally enables DC discharging capabilities to send electricity from the battery to a utility grid and DC charging capabilities to charge the battery.

2. The system of claim 1, wherein the battery is located in a vehicle.

3. The system of claim 1, wherein the AC backup module comprises:
a neutral-forming transformer selectively connected to the base charging module; and
a microgrid interconnection device connected to the neutral-forming transformer and at least one of the residential electrical system and the utility grid.

4. The system of claim 3, wherein the microgrid interconnection device connects the AC backup module to the residential electrical system when the AC discharging capabilities are enabled.

5. The system of claim 3, wherein the microgrid interconnection device connects the AC backup module to the utility grid when the DC discharging capabilities are enabled.

6. The system of claim 1, wherein the DC grid integration module comprises a bi-directional DC/AC inverter selectively electrically connected to the base charging module, wherein the bi-directional DC/AC inverter is configured to provide DC to the base charging module when DC charging capabilities are enabled.

7. The system of claim 6, wherein the DC grid integration module further comprises a microgrid interconnection device connected to the bi-directional DC/AC inverter and at least one of the residential electrical system and the utility grid.

8. The system of claim 6, wherein the bi-directional DC/AC inverter is connected to the AC backup module.

9. The system of claim 8, wherein the bi-directional DC/AC inverter is connected to a neutral-forming transformer of the AC backup module.

10. The system of claim 8, wherein the DC grid integration module is connected to an external power source and is configured to selectively send electricity from the external power source to at least one of the residential electrical system and the utility grid.

11. The system of claim 10, wherein the external power source is at least one of a solar array and a stationary battery.

12. The system of claim 1, wherein the base charging module, the AC backup module, and the DC grid integration module are located in separate housings.

13. An alternating-current (“AC”) backup module configured to be selectively connected to a base charging module, the AC backup module enables AC discharging capabilities to the base charging module to send electricity from a battery connected to the base charging module via a charging port to a residential electrical system.

14. The AC backup module of claim 13, wherein the AC backup module comprises:
a neutral-forming transformer selectively connected to the base charging module; and
a microgrid interconnection device connected to the neutral-forming transformer and at least one of the residential electrical system and a utility grid.

15. The AC backup module of claim 14, wherein the microgrid interconnection device connects the AC backup module to the residential electrical system when the AC discharging capabilities are enabled.

16. The AC backup module of claim 13, wherein the battery is located in a vehicle.

17. A direct-current (“DC”) grid integration module configured to be selectively connected to a base charging module, the DC grid integration module enables DC discharging capabilities to send electricity from a battery connected to the base charging module via a charging port to a utility grid and DC charging capabilities to charge the battery.

18. The DC grid integration module of claim 17, wherein the DC grid integration module is selectively connected to the base charging module via an alternating-current (“AC”) backup module that enables AC discharging capabilities to send electricity from the battery connected to the base charging module via the charging port to a residential electrical system.

19. The DC grid integration module of claim 17, wherein the DC grid integration module comprises a bi-directional DC/AC inverter selectively electrically connected to the base charging module, wherein the bi-directional DC/AC inverter is configured to provide DC to base charging module when DC charging capabilities are enabled.

20. The DC grid integration module of claim 19, wherein the DC grid integration module further comprises a microgrid interconnection device connected to the bi-directional DC/AC inverter and at least one of a residential electrical system and the utility grid.
